(19) United States
(12) Patent Application Publication
(10) Pub. No.: US 2012/0278743 A1
(43) Pub. Date: Nov. 1, 2012

(54) COMMON INTERFACE FOR MULTIPLE NETWORK SERVICES

(75) Inventors: Dilnaz I. Heckman, Buckley, WA (US); Yuanbo Guo, Redmond, WA (US); Akinyele O. Akinsoto, Bellevue, WA (US); James D. Harriger, Duvall, WA (US); Smita Ojha, Redmond, WA (US)

(73) Assignee: MICROSOFT CORPORATION, Redmond, WA (US)

(21) Appl. No.: 13/098,025

(22) Filed: Apr. 29, 2011

(51) Int. Cl. G06F 3/048

(52) U.S. Cl. 715/764

(57) ABSTRACT

The formulation of a user interface that is used to access multiple network services. The user interface includes a common interface portion that is common amongst multiple network services. The user interface also includes a service-specific content portion that is specific at least one, but not all, of the network services. In one or more embodiments, the common interface may include navigation control(s) for navigating the service-specific content portion between network services while the common interface portion remains the same. Thus, the user interface may be used to present multiple network services while retaining a portion that has a common look.

### BACKGROUND

There are a variety of services offered over the Internet. For instance, e-mail services, calendar services, contacts services, task services are all currently offered over the Internet. These services are often combined into a single personal information management service. Such personal information management service integrates all of the functions. For instance, a calendar invitation may be sent via e-mail, and if accepted may automatically be added to the calendar. As another example, contacts may be selected to populate the address fields of an e-mail.

Collaborative services are also offered over the Internet. Such collaborative software allows for collaborative authoring of documents. Collaborative services also allow multiple viewers of a document, with perhaps a controller supplementing the view of the document to perform a presentation of the document.

Cloud based services, such as applications and/or data storage are also examples of network services. Here, the client may be relieved of the processing requirements of the offloaded application, and instead, a mere visual interface is provided to the client, with most of the processing occurring external to the client (i.e., in the cloud). Similarly, there might be a music storage service that stores music for the client, and which provides the music data to the client as the music is to be rendered. There are thus a wide-variety of network services offered over the Internet.

### BRIEF SUMMARY

At least one embodiment described herein relates to the formulation of a user interface that is used to access multiple network services. The user interface includes a common interface portion that is common amongst multiple network services. For instance, the common interface portion may be the header and/or footer of the user interface. The user interface also includes a service-specific content portion that is specific at least one, but not all, of the network services. In one or more embodiments, the common interface may include navigation control(s) for navigating the service-specific content portion between network services while the common interface portion remains the same. Thus, the user interface may be used to present multiple network services while retaining a portion that has a common look.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a rendering component for rendering a user interface that is used to access multiple network services and which includes at least one portion that is common amongst multiple network services;

FIG. 3 illustrates a broad example of a user interface that includes a common interface portion and a service-specific interface portion;

FIG. 4 illustrates a flowchart of a method for formulating a user interface that is used to access multiple network services and which includes at least one portion that is common amongst multiple network services;

FIG. 5 illustrates a flowchart of a method for navigating the user interface generated by the method of FIG. 4;

FIG. 6 illustrates a first state of a user interface having a common interface portion at its header and footer, and a service-specific interface portion therebetween related to a central administration service;

FIG. 7 illustrates a second state of the user interface have a common interface portion at its header, and a service-specific interface portion below related to a personal information management service; and

FIG. 8 illustrates a third state of the user interface have a common interface portion at its header and footer, and a service-specific interface portion therebetween related to a collaboration service.

### DETAILED DESCRIPTION

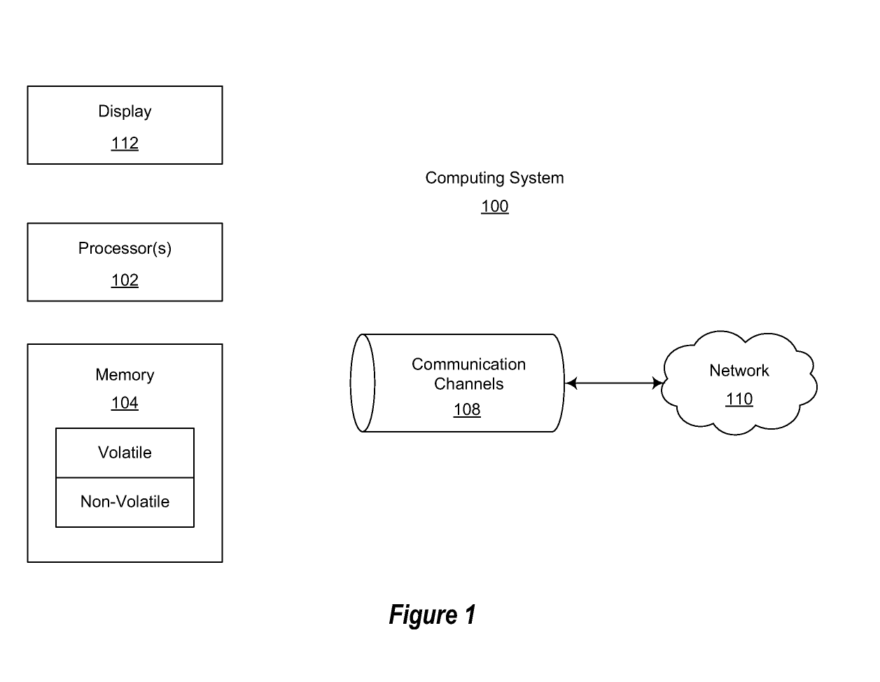

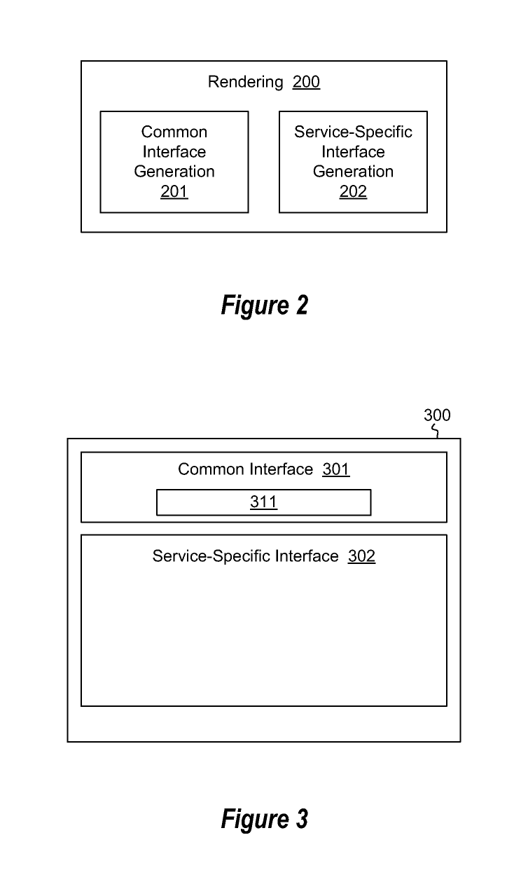

In accordance with embodiments described herein, the formulation of a user interface that is used to access multiple network services is described. The user interface includes a common interface portion that is common amongst multiple network services. The user interface also includes a service-specific content portion that is specific at least one, but not all, of the network services. In one or more embodiments, the common interface may include navigation control(s) for navigating the service-specific content portion between network services while the common interface portion remains the same. Thus, the user interface may be used to present multiple network services while retaining a portion that has a common look. First, some introductory discussion regarding computing systems will be described with respect to FIG. 1. Then, the embodiments of the user interface and its formulation will be described with respect to FIGS. 2 through 8.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems. As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system may also include a display 112 that may display one or more user interfaces that a user of the computing system may interface with.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a rendering component 200 for rendering a user interface that is used to access multiple network services and which includes at least one portion that is common amongst multiple network services. The rendering component 200 includes a common interface generation component 201 and a service-specific interface generation component 202. FIG. 2 is provided as a conceptual example of a structure that may be used to generate the user interfaces described herein. Although not required, the rendering component 200 may be a component of a larger program, may be used for other functions other than rendering (such as displaying), or may actually be implemented with multiple interacting components. Likewise, the components 201 and 202 are illustrated, but such illustration does not represent that the common interface generation and the service-specific interface portions are necessarily generated by separate components, nor that there is any given single component that generates the respective portions of the user interface.

Although the rendering component 200 may be implemented in hardware, the rendering component 200 may also be implemented in computer memory in response to a computer (such as computer 100 of FIG. 1) accessing a computer program product that comprises one or more computer-readable media having thereon computer-executable instructions, and also by one or more processors (such as processors 102) of the computing system executing the computer-executable instructions.

FIG. 3 illustrates a broad example of a user interface 300 that includes a common interface portion 301 that is common amongst the multiple network services, and a service-specific interface portion 302 of the user interface. The common interface portion 301 is common amongst all of a set of network services, which set perhaps even includes all of the network services that are accessible through the user interface 300. Examples of such services may include, for example, Web services. On the other hand, the service-specific interface portion 302 is specific to a subset (and perhaps just one of) the services in the set of services.

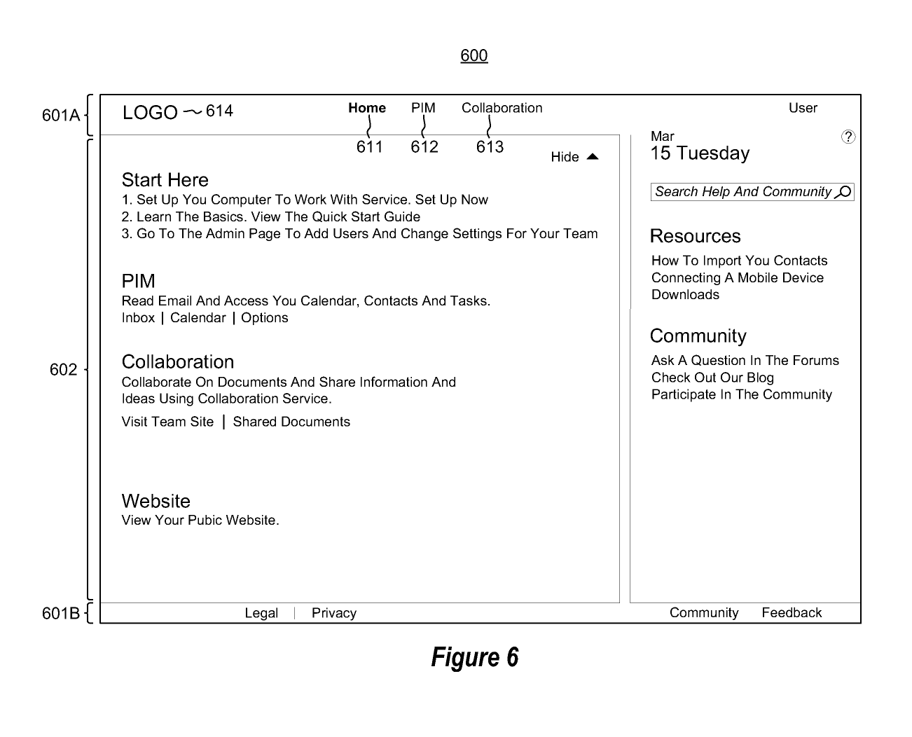

The placement of the common interface portion 301 and the service-specific interface portion 302 within the user interface 300 of FIG. 3 is not intended to imply any restriction as to the placement of the common interface portion 301 and the service-specific interface portion 302 within an actual user interface. There are limitless possibilities on such placement. As an example only (and in the specific example of FIGS. 6 through 8), the common interface portion corresponds to the header and sometimes footer of the user interface. The common interface portion may be one contiguous portion, and may be multiple non-contiguous portions of the user interface. For example, the common interface portion may include the header of the user interface and the footer of the user interface, which are not contiguous with each other. The service-specific interface portion may likewise be contiguous (as in the example of FIGS. 6 through 8), or may include multiple discrete portions of the user interface.

The common interface portion 301 includes at least one navigation control 311 that may be used to navigate the user interface to from one network service to another such that the service-specific interface portion 302 changes from one service to another. In a more specific example that follows with respect to FIGS. 6 through 8, the at least one navigation control includes a navigation control for each of the network services that are common amongst the common interface portion.

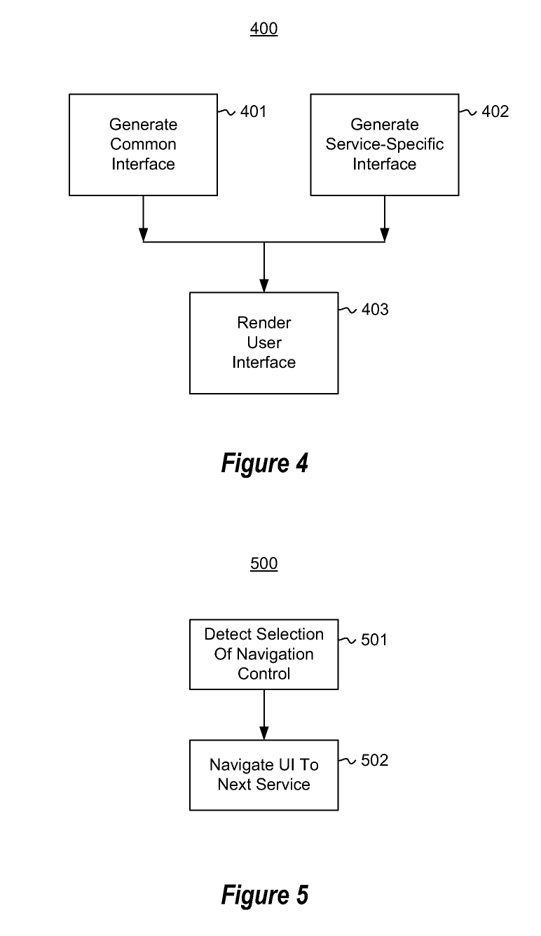

FIG. 4 illustrates a flowchart of a method 400 for formulating a user interface that is used to access multiple network services and which includes at least one portion that is common amongst a plurality of network services. The method 400 includes an act of a computing system generating the common interface portion (act 401), and an act of a computing system generating the service-specific interface portion (act 402). For instance, in the example structure of FIG. 2 and the example user interface of FIG. 3, the common interface generation component 201 may generate the common interface portion 301, and the service-specific interface generation component 202 may generate the service-specific interface portion 302. There is no ordering requirement as far as which portion is generated first, as both portions may even be generated at least partially simultaneously Once generated, the user interface may be rendered on a display (act 403), such as display 112 of FIG. 1.

FIG. 5 illustrates a flowchart of a method 500 for navigating the user interface generated by the method 400 of FIG. 4. Upon detecting a selection of the navigation control (act 501), the user interface navigates the service-specific interface portion to another of the set of network services (act 502).

The broader concepts described with respect to FIGS. 2 through 5 will now be demonstrated through a very specific example with respect to FIGS. 6 through 8, which show various states of a user interface as the service-specific interface portion is navigated from one service to another.

FIG. 6 illustrates a first state of a user interface 600 having a common interface portion that includes a header common interface portion 601A located as a header of the user interface 600, and a footer common interface portion 601B located as a footer of the user interface 600. In this case, the header common interface portion 601A has several navigation controls 611, 612 and 613, each corresponding to a service offered by the user interface. In one embodiment, the services offered by the user interface are determined by the rendering component 200 of FIG. 2 accessing metadata that describes which services are available to the user. In that case, services that are not available to the user may perhaps have no associated navigation control in the common interface portion. For instance, perhaps different users have a different set of services available to each of the users.

By selecting the corresponding navigation control 611, 612 and 613, the service-specific content is populated in the common interface portion 601A. For instance, in FIG. 6, by selecting the “Home” text navigation control, the service-specific interface portion 602 is populated with controls, text, image data and other content associated with a central administration service. This central administration service may be used to set up a computer or user to work with a particular service, or perhaps navigate to another more specific service. In addition, perhaps there may be basic components of the other services that are included in the central administration service. In addition, there may be calendar data, help information, and forum access points that are available from the central administration service. The first state 600 of the user interface also shows a footer common interface portion 601B having links to certain information such as legal information, privacy information, community information, and feedback controls.

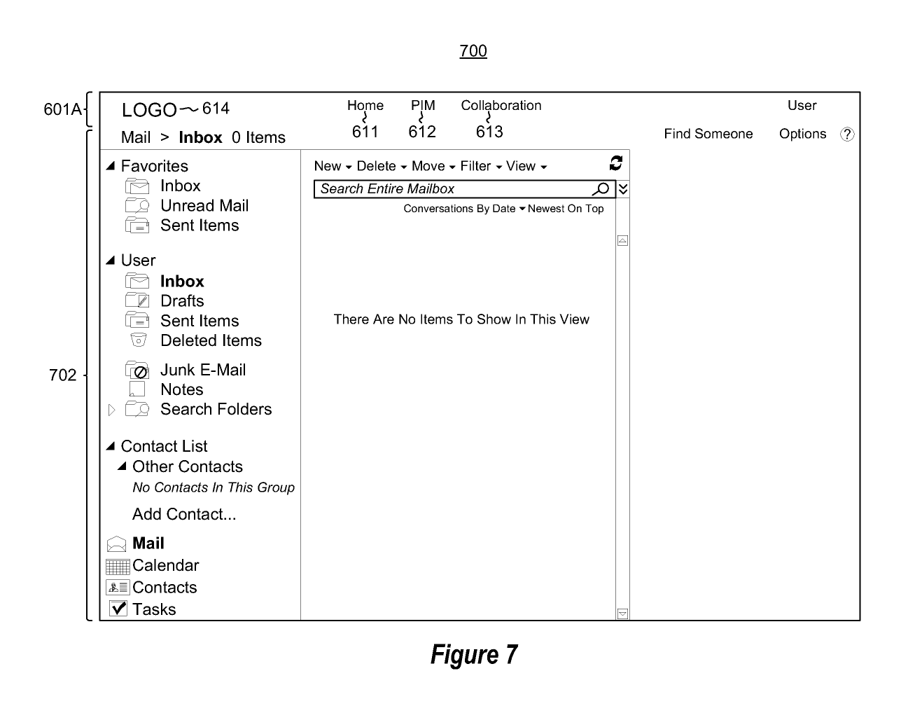

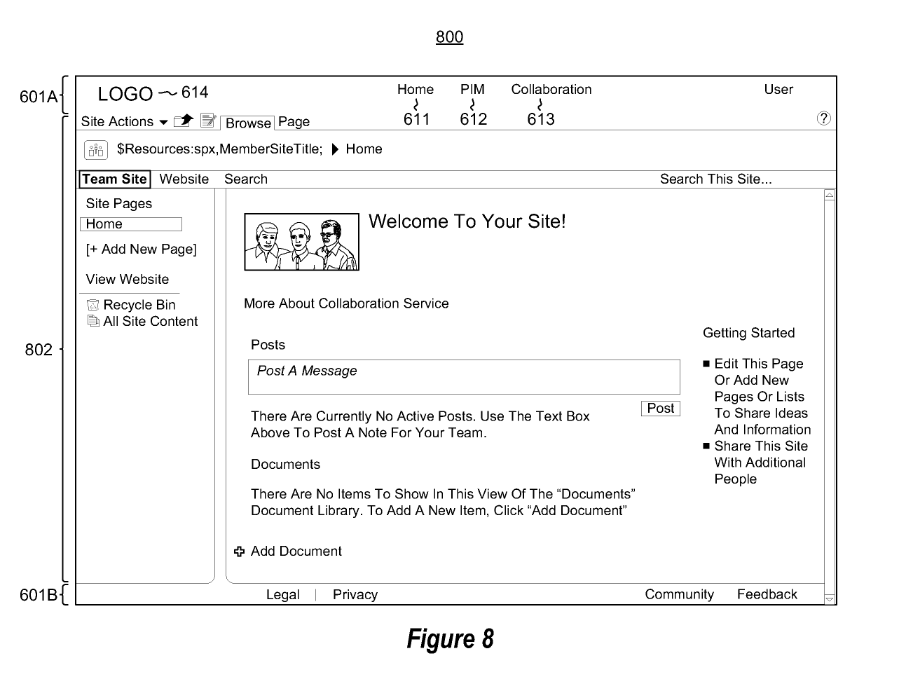

FIG. 7 illustrates a second state 700 of the user interface have a common interface portion 601A at its header, and a service-specific interface portion 702 therebelow related to a personal information management service. This second state may have been arrived at by, for example, selecting the PIM text link 612 in FIG. 6 or FIG. 8. Note that the header common interface portion 601A has not changed from the first state of FIG. 6 to the second state of FIG. 7, which demonstrates that the common interface portion may be uniform across multiple services. The footer common interface portion 601B is not shown in FIG. 7. However, in the case where the footer common interface portion 601B is truly common across the central administration service and the PIM service, the footer common interface portion 601B would also appear in the second state 700 of the user interface.

FIG. 8 illustrates a third state 800 of the user interface have a common header interface portion 601A, a common footer interface portion 601B, and a service-specific interface portion 802 therebetween related to a collaboration service. This third state may have been arrived at by, for example, selecting the collaboration text link 613 in FIG. 6 or FIG. 7. Note that the common header interface portion 601A and the common footer interface portion 601B have not changed from the first state of FIG. 6 to the third state of FIG. 8, once again demonstrating that that the common interface portion may be uniform across multiple services.

The common interface portion may include a number of features that allow the look and feel of the common interface portion to remain consistent across multiple services. For instance, the common interface portion may include a style that is specific to a user, a provider of the service, or to a retailer of the service. For instance, the style may be a text font or size of the text within the common interface portion, a background feature such as color or texture, a logo (such as logo 614), a layout or the like. Such style information may be made available to the rendering component 200 when constructing the common interface portion 301.

By using the principles described herein, the user may more easily navigate from one service to another by interfacing with more familiar interface controls that are part of a common interface portion that is common across multiple (and perhaps all) of the network services offered through the user interface. The user (or the service provider or service retailer) may additionally customize that common user interface. Thus, the user has a more familiar and more easily navigatable experience when navigating multiple services.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer storage media having thereon computer-executable instructions that are structured such that, when executed by one or more processors of a computing system, cause the computing system to perform a method for formulating a user interface that is used to access multiple network services and which includes at least one portion that is common amongst a plurality of network services, the method comprising:
an act of a common interface generation component generating a common interface portion of the user interface, the common interface portion being common amongst the plurality of network services; and
an act of a service-specific content generation component generating a service-specific content portion of the user interface, the service-specific portion being specific to at least one, but not all, of the plurality of network services.

2. The computer program product in accordance with claim 1, wherein the plurality of network services represents all of the network services that may be accessed through the user interface.

3. The computer program product in accordance with claim 1, wherein the plurality of network services each comprise Web services.

4. The computer program product in accordance with claim 1, wherein the common interface component includes at least one navigation control that may be used to navigate the user interface to from one network service to another such that the service-specific content portion changes.

5. The computer program product in accordance with claim 4, wherein the at least one navigation control includes a navigation control for each of the plurality of network services.

6. The computer program product in accordance with claim 1, wherein the common interface portion of the user interface comprises a header portion of the user interface.

7. The computer program product in accordance with claim 6, wherein the common interface portion of the user interface also comprises a footer portion of the user interface.

8. The computer program product in accordance with claim 1, wherein the common interface portion of the user interface comprises a footer portion of the user interface.

9. The computer program product in accordance with claim 1, wherein the plurality of network services are identified by metadata available to the common interface generation component.

10. The computer program product in accordance with claim 1, wherein the common interface generation component generates a style of the common interface.

11. The computer program product in accordance with claim 10, wherein the style of the common interface is specific to a user.

12. The computer program product in accordance with claim 10, wherein the style of the common interface is specific to a retailer of at least one of the plurality of network services.

13. The computer program product in accordance with claim 10, wherein the style of the common interface comprises text.

14. The computer program product in accordance with claim 10, wherein the style of the common interface comprises a font.

15. The computer program product in accordance with claim 10, wherein the style of the common interface comprises a background.

16. The computer program product in accordance with claim 10, wherein the style of the common interface comprises a logo.

17. The computer program product in accordance with claim 10, wherein the style of the common interface comprises a layout.

18. The computer program product in accordance with claim 1, wherein the user interface is rendered on a display.

19. A method for formulating a user interface that is used to access multiple network services and which includes at least one portion that is common amongst a plurality of network services, the method comprising:
an act of a computing system generating a common interface portion of the user interface, the common interface portion being common amongst a plurality of network services, the common interface portion includes at least one navigation control;
an act of the computing system generating a service-specific content portion of the user interface, the service-specific portion being specific to a at least one of the plurality of network services;
an act of the computing system detecting a selection of the navigation control; and
an act of the computing system navigating the service-specific portion to another of the plurality of network services.

20. A computer program product comprising one or more computer storage media having thereon computer-executable instructions that are structured such that, when executed by one or more processors of a computing system, cause the computing system to perform a method for formulating a user interface that is used to access multiple network services and which includes at least one portion that is common amongst a plurality of network services, the method comprising:
an act of a common interface generation component generating a common interface portion of the user interface, the common interface portion being common amongst the plurality of network services and comprising at least one of a header portion or a footer portion of the user interface; and
an act of a service-specific content generation component generating a service-specific content portion of the user interface, the service-specific portion being specific to one of the plurality of network services,
wherein the common interface component includes a navigation control for each of the plurality of network services and that may be used to navigate the service-specific content portion to a corresponding network service.
